(19) United States
(12) Patent Application Publication
(10) Pub. No.: US 2013/0191242 A1
(43) Pub. Date: Jul. 25, 2013

(54) Fit Recommendations

(71) Applicants: Dirk H. Daniel, Munich (DE); Stephen G. Eneberg, Lynnwood, WA (US)

(72) Inventors: Dirk H. Daniel, Munich (DE); Stephen G. Eneberg, Lynnwood, WA (US)

(73) Assignee: Leonhard Kurz Stiftung & Co. KG, Furth (DE)

(21) Appl. No.: 13/805,266

(22) PCT Filed: Jun. 24, 2010
(86) PCT No.: PCT/US10/39811

§ 371 Date: Apr. 15, 2013

(30) Foreign Application Priority Data
Jun. 21, 2010 (DE) 10 2010 024 523.2

(51) Int. Cl. G06Q 30/06

(52) U.S. Cl. CPC G06Q 30/0631
USPC 705/26.7

(57) ABSTRACT

Disclosed are various embodiments for fit recommending. For example, in some embodiments, a method includes a step of inputting a user item fit corresponding to a user item and target item from a user. The method further includes the step of drawing, using a computing resource, a chain of at least one correlation between the user item fit and a target item fit corresponding to the target item. Further, the method includes the step of generating, using the computing resource, a fit recommendation for the user regarding the target item comprising the target item fit.

### BACKGROUND

Sizes of products can vary by manufacturer. In other words, even though two products made by two different manufacturers may be labeled the same size, both products may not fit a particular customer. For products sold online, this size variance can result in returns of merchandise due to lack of fit and deter such purchases.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a data communications network according to various embodiments of the present disclosure.

FIGS. 2-4 are drawings of examples of network pages rendered by a client in the data communications network of FIG. 1 according to various embodiments of the present disclosure.

FIG. 5 is a flowchart illustrating one example of functionality implemented as portions of fit recommending application executed in a computing resource in the data communications network of FIG. 1 according to various embodiments of the present disclosure.

FIG. 6 is a drawing of an example of correlations between item fits stored in the computing resource in the data communications network of FIG. 1 according to various embodiments of the present disclosure.

FIG. 7 is a flowchart illustrating one example of functionality implemented as portions of box 506 of the fit recommending application executed in a computing resource in the data communications network of FIG. 1 according to various embodiments of the present disclosure.

FIG. 8 is a schematic box diagram that provides one example illustration of a computing resource employed in the data communications network of FIG. 1 according to various embodiments of the present disclosure.

### DETAILED DESCRIPTION

The present application describes various embodiments of systems, devices, and methods for fit recommending. In one embodiment among others, a present user inputs information regarding the fit of one or more items. For example, a present user may provide the brand and size for several shoes that the user owns. Since sizes vary according to brand, the sizes entered may be different, but both shoes nonetheless fit the present user and are correlated. As the present user and other users enter their fit information, a database of correlations between these items that fit is assembled. Accordingly, other brands and sizes may be correlated based on other user inputs to the brands and sizes input by the present user. The present user can then select a target item, and based on the correlations between the target item and items for which the present user has already provided fit information, a fit recommendation can be generated for the present user. In the following discussion, a general description of the system and its components is provided, followed by a discussion of the operation of the same.

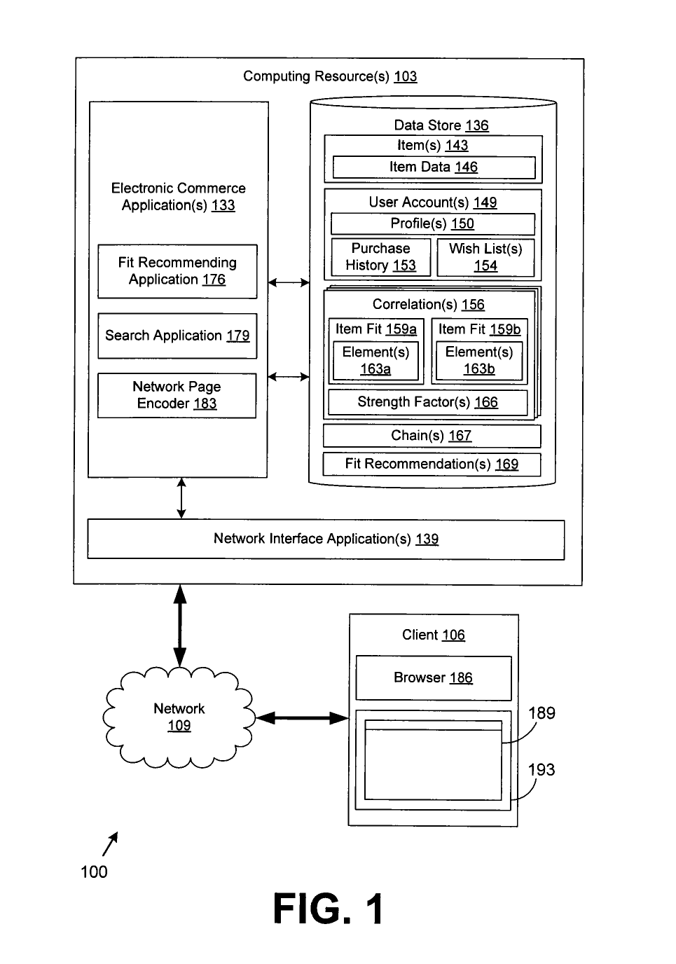

With reference to FIG. 1, shown is a data communications network 100 according to various embodiments. The data communications network 100 includes a computing resource 103, a client 106, and a network 109. The network 109 includes, for example, the Internet, intranets, extranets, wide area networks (WANs), local area networks (LANs), wired networks, wireless networks, or other suitable networks, etc., or any combination of two or more such networks.

The computing resource 103 may comprise, for example, a server computer or any other computing device or system providing computing capability. The computing resource 103 may represent multiple computer systems arranged, for example, in one or more server banks or other arrangements. To this end, the computing resource 103 may comprise, for example, a cloud computing resource, a grid computing resource, and/or any other distributed computing arrangement. Such computer systems may be located in a single installation or may be dispersed among many different geographical locations. For purposes of convenience, the computing resource 103 is referred to herein in the singular. However, in one embodiment, the computing resource 103 represents a plurality of computer systems arranged as described above.

Various applications and/or other functionality may be executed in the computing resource 103 according to various embodiments. Also, various data is stored in a data store 136 that is accessible to the computing resource 103. The data store 136 may be representative of a plurality of data stores as can be appreciated. The data stored in the data store 136, for example, is associated with the operation of the various applications and/or functional entities described below.

The data stored in the data store 136 includes, for example, item(s) 143, user account(s) 149, correlation(s) 156, chain(s) 167, fit recommendation(s) 169, and potentially other data. An item 143 includes a good, a product, a service, and/or one or more of a variety of other items that are selected according to a fit. For example, an item 143 may be a shoe, clothing, sports equipment, or contacts, which are items 143 that a user might desire to try on before purchasing.

In some embodiments, a user account 149 corresponds to a user and at least one profile 150, a purchase history 153, and at least one wish list 154. One of the profiles 150 corresponds to the user, and other profiles 150 may correspond to other parties who are friends, parents, children, relatives, and/or other parties otherwise associated with the user. Also, the user account 149 may correspond to one or more wish list(s) 154, and each wish list 154 includes a listing a plurality of items 143 desired by one of a user, another user, and/or another party corresponding to a profile 150 associated with the user account 149.

The purchase history 153 includes information related to purchases of items 143 by a user. In some embodiments, the purchase history 153 includes information regarding items 143 that were purchased and then returned, and the reason regarding the return (e.g., improper fit) may be included in the purchase history 153 as well.

A correlation 156 includes an association of a first item fit 159a and a second item fit 159b. In some embodiments, a correlation 156 includes an association of the first item fit 159a a corresponding to a first one of a plurality of items 143 with the second item fit 159b corresponding to a second one of the plurality of items 143. In some correlations 156, the first item fit 159a and the second item fit 159b correspond to a first user. In other correlations 156, the first item fit 159a corresponds to a first user, and the second item fit 159b corresponds to a second user.

Each item fit 159a, 159b includes at least two fit elements 163a, 163b. A fit element 163 may include a brand, a size, a weight, a length, a height, a depth, a style, a model, a material, a fabric, an arch, a cut, a category, a sub-category, and/or another property or feature of an item 143. For example, an item fit 159 may include a brand (e.g., Michael Kors) and a size (e.g., 8.5) as the two fit elements 163. In some embodiments, at least one correlation 156 is associated with a profile 150 and/or at least one item fit 159 is associated with a profile 150. An item fit 159 may correspond to an item 143.

A user item fit 159 is input from a user from a purchase history 153, a survey, a widget executed in a rendered network page 189 on a client 106, and/or another feature useful for gathering fit elements 163 included in an item fit 159, as will be discussed further below. In some embodiments, a correlation 156 is associated with a strength factor 166, which may indicate the number of occurrences of the correlation 156 or be based at least in part on feedback from a user. An item fit 159 or a correlation 159 corresponding to a profile 150 associated with a user may be updated or deleted based at least in part on a return of an item 143. Also, a strength factor 166 associated with a correlation 156 including an item fit 159 corresponding to an item 143 may updated based at least in part on a return of the item 143.

The fit recommendation(s) 169 stored in the data store 136 each include at least one fit element 163 corresponding to a target item 143 input by a user. For example, in some embodiments, the fit recommendation 169 may include a size 213. In some embodiments, the fit recommendation 169 includes a target item fit 163.

As an illustrative example, a first user has a first user account 149, and the first user account 149 is associated with a first profile 150 corresponding to the first user. Additionally, a grandparent of the first user is a second user corresponding to a second user account 149 and a second profile 150. The grandparent has authorized the first user to associate the second profile 150 with the first user account 149. Therefore, the second profile 150, which includes at least one item fit 159 and/or at least one correlation 156, is accessible to the first user. Consequently, the first user is able to obtain fit recommendations 169 corresponding to the grandparent without requesting one or more fit elements 163 from the grandparent.

The components executed on the computing resource 103, for example, include an electronic commerce application 133, a network interface application 139, and other applications, services, processes, systems, engines, or functionality not discussed in detail herein. The electronic commerce application 133 is executed in order to facilitate the online purchase of items 143 over the network 109. The electronic commerce application 133 also performs various backend functions associated with the online presence of a merchant in order to facilitate the online purchase of items 143 as will be described. For example, the electronic commerce application 133 generates network pages 189 such as web pages or other types of network content that are provided to clients 106 for the purposes of selecting items for purchase, rental, download, lease, or other form of consumption as will be described.

The electronic commerce application 133 further includes a fit recommending application 176, a search application 179, and a network page encoder 183. In some embodiments, the fit recommending application 176 includes a search application 179 and a network page encoder 183. The fit recommending application 176 is executed to input a target item 143 from a user and generate a fit recommendation 169 based at least in part on a target item 143 and a user item fit 159. As will be discussed in further detail below, the fit recommending application 176 draws a chain 167 of at least one correlation 156 between the user item fit 159 and a target item fit 159 corresponding to the target item 143 input by the user.

In some embodiments, the search application 179 is executed to input a search query from a user and generate search results based at least in part on the search query. The search application 179 is further executed to input a selection of one or more search results from the user, the selection corresponding to a target item 143. Additionally, the network page encoder 183 encodes network pages 189 to facilitate the functionality of the fit recommending application 176, and examples of network pages 189 will be discussed in further detail below.

The client 106 is representative of a plurality of client devices that may be coupled to the network 109. The client 106 may comprise, for example, a processor-based system such as a computer system. Such a computer system may be embodied in the form of a desktop computer, a laptop computer, a personal digital assistant, a cellular telephone, set-top box, music players, web pads, tablet computer systems, a gaming console, or other devices with like capability.

The client 106 may be configured to execute various applications such as a browser 186 and/or other applications. The browser 186 may be executed in a client 106, for example, to access and render network pages 189, such as web pages, or other network content served up by the computing resource 103 and/or other servers. The client 106 may be configured to execute applications beyond browser 186 such as, for example, email applications, instant message applications, and/or other applications.

When executed in a client 106, the browser 186 renders network pages 189 on a respective display device 199 and may perform other functions. The browser 186 accesses network pages 189 such as web pages or other types of content from the computing resource 103 in order to access the functionality of the fit recommending application 176 and other components implemented in the computing resource 103 as will be described.

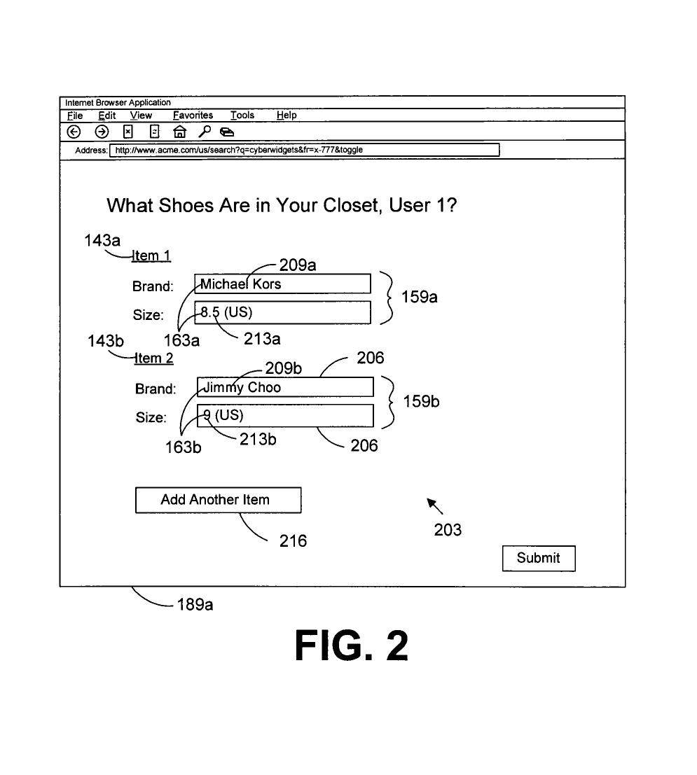

Referring next to FIGS. 2-4, various network pages 189 (FIG. 1) generated in association with the operation of the fit recommending application 176 (FIG. 1) are described. It is understood that such network pages 189 are merely examples of the many different network pages 189 that may be generated to accomplish the various purposes discussed. To this end, the components included in the various network pages 189 are presented herein as examples, whereas other types of components may be employed in their place to accomplish the same underlying purpose. Furthermore, the various components may be manipulated using various input devices such as keyboards, a mouse, microphones, and other devices as can be appreciated.

FIGS. 2-4 illustrate an example of various network pages 189 (FIG. 1), denoted herein as network pages 189a, 189b, and 189c. The network pages 189 are rendered on a display device 199 (FIG. 1) of a client 106 (FIG. 1). Information stored in a data store 136 (FIG. 1) on a computing resource 103 (FIG. 1) may be presented to a user in the network pages 189 communicated by the network interface application 139 (FIG. 1) over the network 109 (FIG. 1) to the client 106. Also, the network page 189 provides one example of the many different network pages 189 that may be created for different types of display devices 199 employed on a respective client 106. For example, the network pages 189 may be formatted differently to fit on a small display screen of a personal digital assistant or other mobile device, etc. Additionally, different graphical user interface (GUI) components may be used.

FIG. 2 illustrates a network page 189a including a survey 203 for inputting a plurality of user item fits 159 (FIG. 1), denoted herein as user item fits 159a,159b. Specifically, the network page 189a includes fields 206 for inputting a plurality fit elements 163 (FIG. 1), denoted herein as fit elements 163a 163b corresponding to user item fits 159a, 159b. In this example, these user item fits 159a, 159b correspond to respective user items 143 (FIG. 1), denoted herein as user items 143a, 143b. In the example of a network page 189a illustrated in FIG. 2, the two user items 143a, 143b are shoes. The corresponding user item fits 159a, 159b comprise fit elements 163a,163b, which include respective brands 209 (denoted herein as brands 209a, 209b) and respective sizes 213 (denoted herein as sizes 213a, 213b). Additionally, in some embodiments, more or fewer than two item fits 159a, 159b may be entered in the survey 203. For example, the network page 189a includes a button 216 that a user may press in order to add another item fit 159 corresponding to another user item 143.

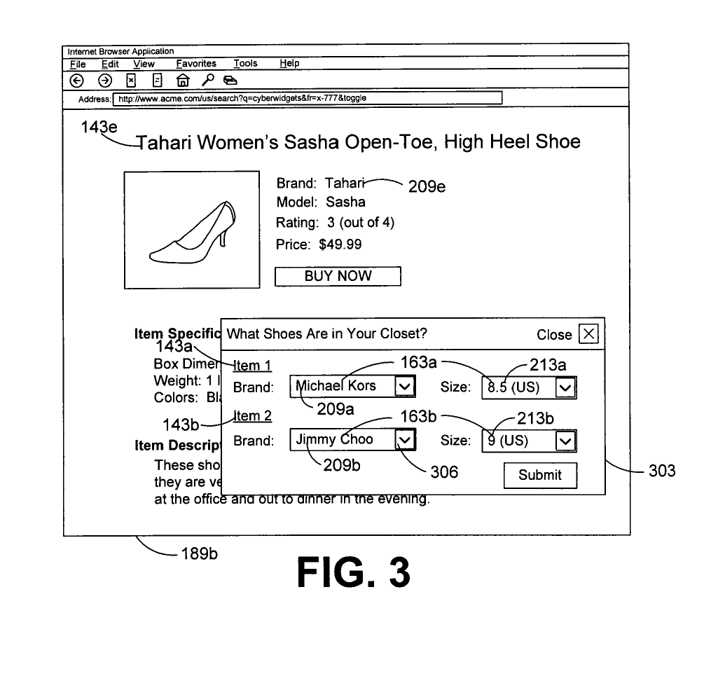

FIG. 3 illustrates a network page 189b that is an item detail page including a widget 303 for inputting a plurality of user item fits 159a, 159b (FIG. 2) using a menu 306. Specifically, the network page 189b includes menus 306 for inputting fit elements 163a, 163b (FIG. 2) corresponding to user item fits 159a, 159b that correspond to user items 143a, 143b (FIG. 2). In the example of a network page 189b illustrated in FIG. 3, the two user items 143a, 143b are shoes providing one example of correlated fit elements 163a,163b including respective brands 209a, 209b (FIG. 2) and sizes 213a, 213b (FIG. 2).

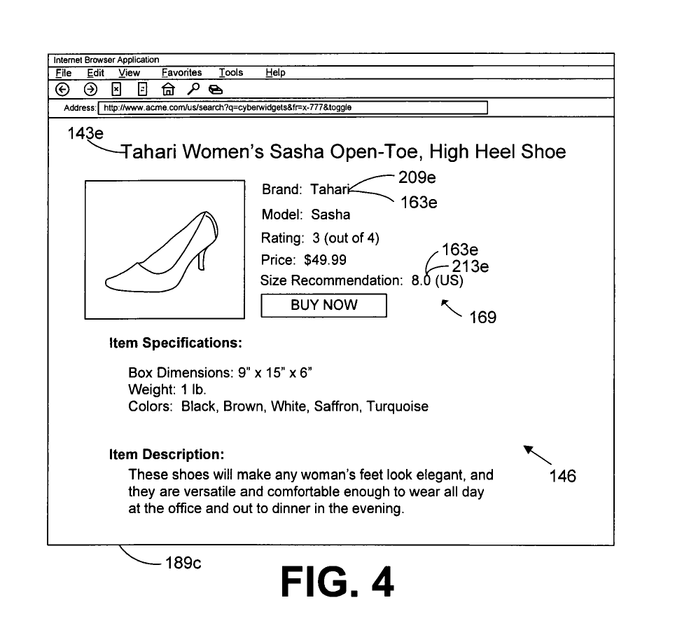

FIG. 4 illustrates a network page 189c that is an item detail page including item data 146 (FIG. 1) regarding a target item 143, denoted herein as target item 143e. In the example of a network page 189c illustrated in FIG. 4, the item data 146 includes an item image, item description, item specification, model, rating, price, and other information regarding the target item 143e. Also, similar to the network page 189b illustrated in FIG. 3, the example of network page 189c in FIG. 4 includes a fit element 163 (denoted herein as fit element 163e) of a brand 209e. Additionally, the network page 189c illustrates an example of a fit recommendation 169 (FIG. 1) including the fit element 163e, which is a size 213e.

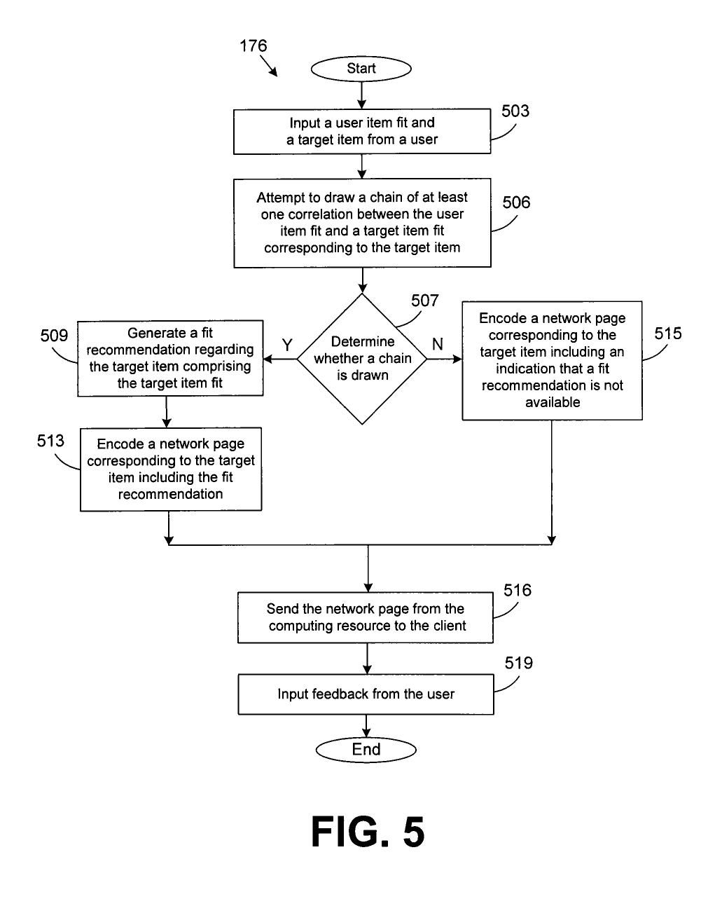

Referring next to FIG. 5, shown is a flowchart that provides one example of the operation of a portion of the fit recommending application 176 (FIG. 1) according to various embodiments. It is understood that the flowchart of FIG. 5 provides merely an example of the many different types of functional arrangements that may be employed to implement the operation of the portion of the fit recommending application 176 as described herein. As an alternative, the flowchart of FIG. 5 may be viewed as depicting an example of steps of a method 176 implemented in the computing resource 103 (FIG. 1) according to one or more embodiments.

Beginning with box 503, a user item fit 159 (FIG. 1) and a target item 143 (FIG. 1) are input from a user. In the example described in the following paragraphs, the target item 143 is denoted as target item 143e, which is a “Tahari Women's Sasha Open-Toe, High Heel Shoe.” From the target item 143e input by the user, at least one target fit element 163, such as a brand 209e (e.g., Tahari) may be determined. In some embodiments, the user item fit 159 and the target item 143 are input from a user via a client 106 (FIG. 1) in communication with a computing resource 103 over a network 109 (FIG. 1). In some embodiments, the user item fit 159 is input from a user from a purchase history 153 (FIG. 1), a survey 203 (FIG. 2), a widget 303 (FIG. 3), and/or another feature useful for gathering fit elements 163 (FIG. 1) included in a user item fit 159. As discussed above, an item fit 159 includes at least two fit elements 163.

In some embodiments, the target item 143 is input as a selection from a plurality of search results. For example, a search query is input from a user, and the computing resource 103 generates a plurality of search results based at least in part on the search query. A search result, which includes the target item 143, is selected by the user to input the target item 143.

Additionally, correlations 156 and/or item fits 159 that are input by a user that appear suspicious or improbable may not be accepted or may be deleted. For example, a correlation 156 including an association of first item fit 159 corresponding to an item 143 that is a shoe including a size 213 of 10 with a second item fit 159 corresponding to another shoe including a size 213 of 7 might be deleted because the association is so unlikely due to the great difference in the sizes 213. Alternatively, a strength factor 166 may be updated or adjusted responsive to a determination that a correlation 156 or item fit 159 is suspicious or improbable.

Additionally, in some embodiments, an item fit 159 is only input by a user associated with a user account 149. For example, to input the item fit 159, the user would have to provide a login name and password and obtain authorization. Therefore, the likelihood of fraudulent item fits 159 being input is lowered.

In box 506, the computing resource 103 attempts to draw a chain 167 (FIG. 1) of at least one correlation 156 (FIG. 1) between the user item fit 159 and a target item fit 159 (FIG. 1), where the target item fit 159 corresponds to the target item 143. As discussed above, a correlation 156 includes an association of a first item fit 159 corresponding to a first one of a plurality of items 143 with a second item fit 159 corresponding to a second one of a plurality of items 143.

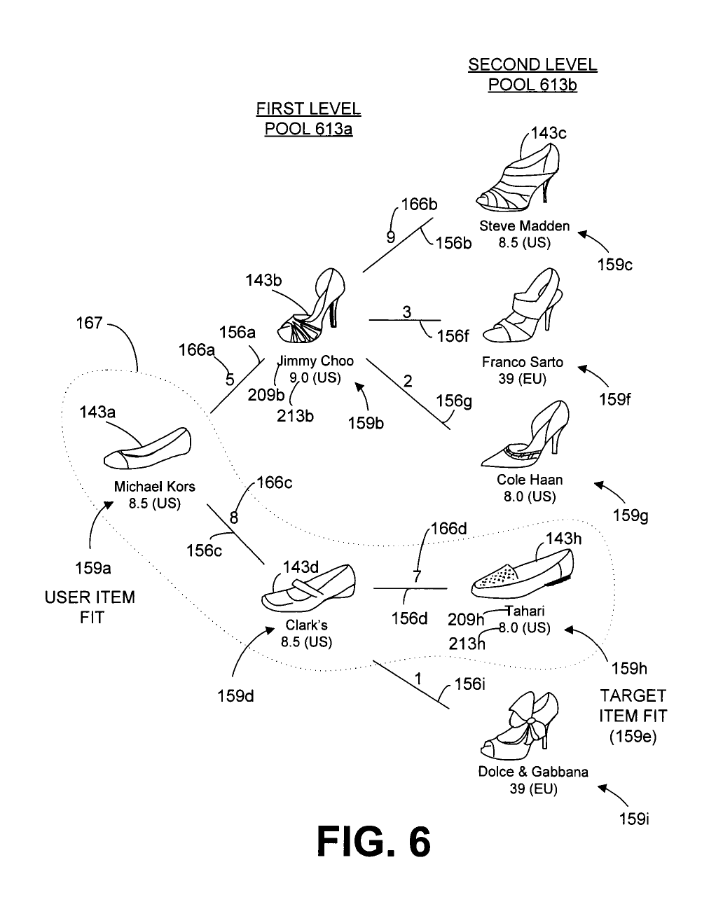

Referring to FIG. 6, shown is a drawing including an example of a plurality of correlations 156 (FIG. 1) stored in the computing resource 103 (FIG. 1) in the data communications network 100 (FIG. 1) according to various embodiments of the present disclosure. The plurality of correlations 156 include correlations 156 denoted herein as correlation 156a, correlation 156b, correlation 156c, correlation 156d, correlation 156f, correlation 156g, and correlation 156i.

The correlation 156a includes an association of a first item fit 159 (e.g., user item fit 159a) corresponding to a first one (e.g., item 143a) of a plurality of items 143 and a second item fit 159 (e.g., item fit 159b) corresponding to a second one (e.g., item 143b) of the plurality of items 143. Similarly, the correlation 156c includes an association of a first item fit 159 (e.g., user item fit 159a) corresponding to a first one (e.g., item 143a) of a plurality of items 143 and a second item fit 159 (e.g., item fit 159d) corresponding to a second one (e.g., item 143d) of the plurality of items 143. Further, the correlation 156d includes an association of a first item fit 159 (e.g., user item fit 159d) corresponding to the first one (e.g., item 143d) of the plurality of items 143 and a second item fit 159 (e.g., item fit 159h) corresponding to a second one (e.g., item 143h) of a plurality of items 143.

Additionally, FIG. 6 illustrates an example of a plurality of pools 613, denoted herein as a first level pool 613a of item fits 159 (e.g., item fits 159b and 159d) and a second level pool 613b of item fits 159 (e.g., item fits 159c, 159f, 159g, 159h, and 159i). In other embodiments, additional pools 613 may be included having more or fewer item fits 159. In addition, in the example illustrated in FIG. 6, a strength factor 166 is associated with each correlation 156, and the strength factor 166 indicates a number of occurrences of the correlation 156.

FIG. 6 also includes an example of a chain 167 drawn between a user item fit 159a and a target item fit 159h, where the target item fit 159h corresponds to the target item 143e. Specifically, the chain 167 includes the correlation 156c and the correlation 156d. More or fewer correlations 156 may be included in a chain 167 in other embodiments.

Returning to FIG. 5, in box 507, whether a chain 167 is drawn in box 506 is determined in box 507. Responsive to a determination that a chain 167 is drawn in box 506, a fit recommendation 169 regarding the target item 143 is generated. In box 513, a network page 189 corresponding to the target item 143 is encoded including the fit recommendation 169. The fit recommendation 169 comprises the target item fit 159. Responsive to a determination that a chain 167 is not drawn in box 506, a network page 189 corresponding to the target item 159 is encoded by the computing resource 103 including an indication that a fit recommendation 169 is not available.

As mentioned above, the fit recommendation 169 includes at least one fit element 163. Referring to the example of correlations 156 illustrated in FIG. 6, the target item fit 159h includes fit elements 163h of a brand 209h (e.g., Tahari) and a size 213h (e.g., 8.0 (US)). The fit recommendation 169 that is generated includes at least one fit element 163e (e.g., the size 213h (e.g., 8.0 (US)) of the target item fit 159h. In some embodiments, the fit recommendation 169 generated includes the target item fit 159h.

The network page encoder 183 in the computing resource 103 may encode the network page 189. In some embodiments, the network page 189 is an item detail page. For example, the network page 189c illustrated in FIG. 4 is an item detail page regarding the target item 143e. The network page 189c includes the fit recommendation 169, which in this example is a size 213e (e.g., 8.0 (US)).

In some embodiments, the fit recommendation 169 further includes related item 143 recommendations. For example, referring to FIG. 6, the items 143 related to the item fits 159 that are strongly associated with the user item fit 159a based on the strength factors 166 may be recommended as related item 143 of interest to the user.

In box 516, the network page 189 is sent from the computing resource 103 to the client 106 for rendering in a display device 199. In box 519, feedback is input from the user regarding the fit recommendation 169 or lack thereof. The feedback is retrieved from the user at the client 106, and sent from the client 106 to the computing resource 103 over the network 109. The feedback may be used to update a correlation 156, an item fit 159, a profile 150, a strength factor 166, and/or a fit element 163. In some embodiments, the fit recommendation 169 generated in box 509 is based on feedback previously input from the user or another user regarding another fit recommendation 169.

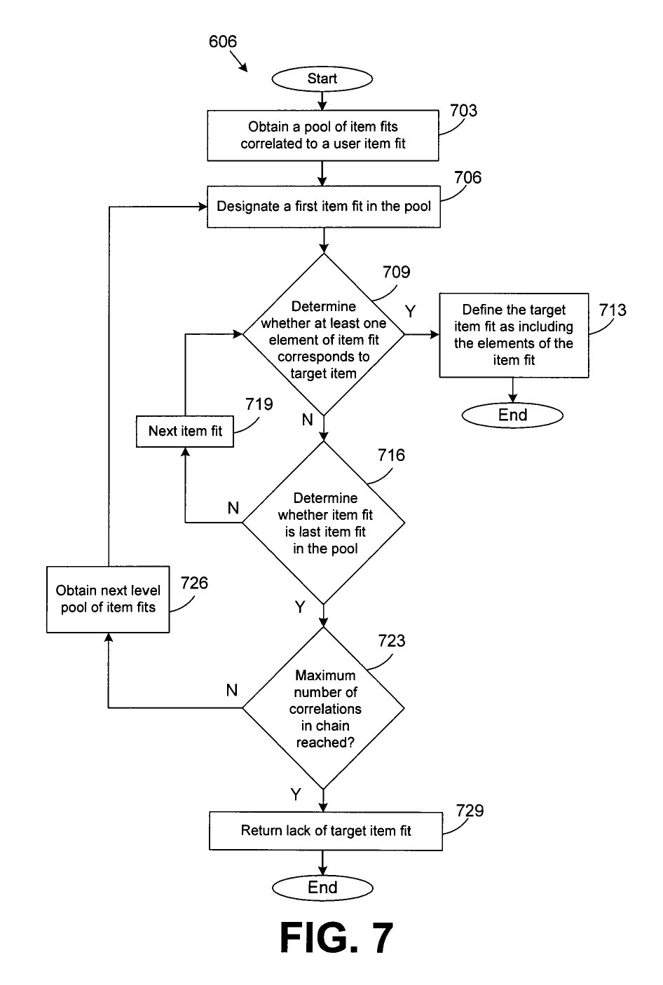

Moving now to FIG. 7, shown is a flowchart that provides one example of the operation of a portion of the fit recommending application 176 (FIG. 1) described in FIG. 5 according to various embodiments. It is understood that the flowchart of FIG. 7 provides merely an example of the many different types of functional arrangements that may be employed to implement the operation of the portion of the fit recommending application 176 as described herein. As an alternative, the flowchart of FIG. 7 may be viewed as depicting an example of box 506 of the method 176 implemented in the computing resource 103 (FIG. 1) according to one or more embodiments.

Beginning with box 703, a pool 613 (FIG. 6) of item fits 159 (FIG. 1) correlated to a user item fit 159 is obtained by the computing resource 103 (FIG. 1). For example, referring to FIG. 6, the user item fit 159a is correlated to the other item fits 159b, 159d as shown by correlations 156a, 156c, and the pool 613 may be obtained by performing a search using the computing resource 103 of the correlations 156 stored in the data store 136 keying on the user item fit 159a.

Referring again to FIG. 7, in box 706, a first item fit 159 in the pool 613 is designated by the computing resource 103. For example, in FIG. 6, the item fit 159b, which is associated with the user item fit 159a in correlation 156a, of the first level pool 613a is designated as the first item fit 159 in box 706. In box 709 of FIG. 7, the computing resource 103 determines whether the fit elements 163 of the item fit 159 under consideration (e.g., the first item fit 159b in FIG. 6) correspond to the target item 143.

For example, with reference to FIG. 6, the computing resource 103 determines whether at least one of the fit elements 163b of the item fit 159b corresponds to the target item 143e (e.g., the “Tahari Women's Sasha Open-Toe, High Heel Shoe”). In this example, a brand 209e (e.g., Tahari), which is a fit element 163, corresponds to the target item 143e, but the fit element 163e of a size 213e is unknown based on the input of the target item 143e from the user. As can be seen in FIG. 6, the brand 209b (e.g., Jimmy Choo) included in the item fit 159b is different from the brand 209e (e.g., Tahari) corresponding to the target item 143e. Hence, none of the fit elements 163b of the first item fit 159b correspond to the target item 143e.

Responsive to the determination that none of the fit elements 163 of the item fit 159 correspond to the target item 143, the computing resource 103 determines whether the item fit 159 is the last item fit 159 in the pool 613 in box 716. For example, referring to FIG. 6, the item fit 159b, which is the item fit 159 under consideration, is not the last item fit 159 in the first level pool 613a because item fit 159d is also included in the first level pool 613a. Responsive to the determination that the item fit 159 is not the last item fit 159 in the pool 613, the next item fit 159 in the pool 613 is selected. In the example illustrated in FIG. 6, the next item fit 159 in the first level pool 613a is item fit 159d.

The computing resource 103 then returns to box 709 and determines whether this next item fit 159 includes at least one fit element 163 that corresponds to the target item 143. Referring to the example illustrated in FIG. 6, the brand 209d (e.g., Clark's) of item fit 159d is different from the brand 209e (e.g., Tahari) corresponding to the target item 143e. Hence, the fit elements 163d of the next item fit 159d do not correspond to the target item 143e.

Then, in box 716, the computing resource determines that the item fit 159d is the last item fit 159 in the pool 613, and the computing resource 103 determines whether a maximum number of correlations 156 in the chain 167 has been reached in box 723. By having a maximum number of correlations 156, the method 176 limits the degrees of separation between the user item fit 159a and the target item fit 159h. In other words, when many correlations 156 are needed in the chain 167 to link the user item fit 159a and the target item fit 159h, it is less likely that the fit recommendation 169 is accurate. However, in some embodiments, the maximum number of correlations 156 permitted depends on one or more of the strength factors 166 associated with the correlations 156 in the chain 167. When the strength factors 166 in the chain 167 are high, this reduces the likelihood that a lengthy chain 167 of correlations 156 will yield an inaccurate fit recommendation 169. Hence, more correlations 156 in the chain 167 may be permitted, and the maximum number of correlations 156 may be increased.

Responsive to a determination that the maximum number of correlations 156 in the chain 167 has been reached, an indication of a lack of target item fit 159e is returned. After box 729, box 506 ends, and the computing resource 103 proceeds to box 513, shown in FIG. 5. Responsive to a determination that the maximum number of correlations 156 in the chain 167 has not been reached, the next level pool 613 of item fits 159 is obtained. Referring to FIG. 6, the next level pool 613 of item fits 159 is the second level pool 613b of item fits 159. The second level pool 613b of item fits 159 includes item fits 159c, 159f, 159g, 159h, 159i. Each of the item fits 159 in the second level pool 613b is associated with at least one of the item fits 159 in the first level pool 613a. Then, in box 706, the computing resource designates a first item fit 159 in the next level pool 613. Referring to the example in FIG. 6, the first item fit 159 is designated as item fit 159c.

Referring again to FIG. 7, the computing resource 103 then proceeds to make the determinations in boxes 709, 716, and 719 until either at least one of the fit elements 163 of an item fit 159 under consideration corresponds to the target item 143 or the item fit 159 is the last item fit 159 in the pool 613 under consideration. Referring to the example in FIG. 6, the item fit 159h includes a fit element 163h that corresponds to the target item 143e (e.g., the “Tahari Women's Sasha Open-Toe, High Heel Shoe”) input by the user. Namely, the brand 209h (e.g., Tahari) corresponds to the target item 143e because the brand 209e (e.g., Tahari) corresponds to the target item 143e. Note that in FIG. 6, the item fit 159h corresponds to another item 143h, as well. For example, like the target item 143e input by the user, the other item 143h is a shoe in this example, but the other item 143h might be a different model of a Tahari shoe such as a flat instead of a high heel.

In box 713, the target item fit 159 is defined as including the fit elements 163 of the item fit 159 under consideration. Referring to the example in FIG. 6, the target item fit 159e is defined as including the brand 209h (e.g., Tahari) and the size 213h (e.g., 8.0 (US)). Accordingly, a chain 167 including two correlations 156c, 156d is drawn between the user item fit 159a and the target item fit 159h corresponding to the target item 143e. After box 713, the box 506 ends, and the computing resource 103 proceeds to box 507, shown in FIG. 5.

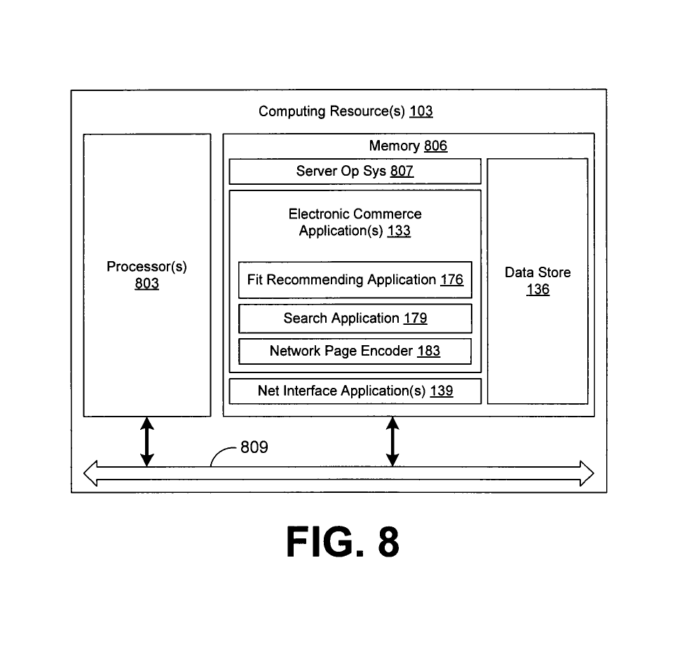

With reference to FIG. 8 shown is a schematic box diagram of the computing resource 103 (FIG. 1) according to an embodiment of the present disclosure. The computing resource 103 includes at least one processor circuit, for example, having a processor 803 and a memory 806, both of which are coupled to a local interface 809. To this end, the computing resource 103 may comprise, for example, at least one server computer or like device. The local interface 809 may comprise, for example, a data bus with an accompanying address/control bus or other bus structure as can be appreciated.

Stored in the memory 806 are both data and several components that are executable by the processor 803. In particular, stored in the memory 806 and executable by the processor 803 are a fit recommending application 176, a search application 179, and a network page encoder 183, and potentially other applications. Also stored in the memory 806 may be a data store 136 (FIG. 1) and other data. In addition, an operating system may be stored in the memory 806 and executable by the processor 803.

It is understood that there may be other applications that are stored in the memory 806 and are executable by the processors 803 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and the memory 806 may represent multiple memories 806 that operate in parallel processing circuits, respectively. In such a case, the local interface 809 may be an appropriate network 109 (FIG. 1) that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the fit recommending application 176, the search application 179, and the network page encoder 183, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 5 and 7 show the functionality and operation of an implementation of portions of the fit recommending application 176. If embodied in software, each box may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each box may represent a circuit or a number of interconnected circuits to implement the specified logical function(s).

Although the flowcharts of FIGS. 5 and 7 show a specific order of execution, it is understood that the order of execution may differ from that which is depicted. For example, the order of execution of two or more boxs may be scrambled relative to the order shown. Also, two or more boxs shown in succession in FIGS. 5 and 7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the fit recommending application 176, the search application 179, and the network page encoder 183, that comprises software or code can be embodied in any computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A computer-readable medium storing a program executable in a computing resource, the program comprising:
code that inputs a target item and a user item fit from a user, the user item fit including a brand and a size;
code that draws a chain of at least one correlation between the user item fit and a target item fit corresponding to the target item, the code that draws the chain further comprising:
code that obtains a pool of item fits correlated to the user item fit;
code that determines whether the brand and size of one of the item fits in the pool correspond to a target item; and
code that defines the target item fit as comprising the brand and size of the one of the item fits in the pool responsive to a determination that the one of the item fits corresponds to the target item;
code that determines whether the one item fit is the last item fit in the pool responsive to a determination that the one item fit does not correspond to the target item;
code that determines whether a number of correlations in the chain is greater than or equal to a maximum number; and
code that obtains a next level pool of item fits correlated to the pool of item fits responsive to a determination that the number of correlations in the chain is not greater than or equal to the maximum number; and
code that generates a size recommendation for the user regarding the target item, wherein the size recommendation includes an indication that a target item fit is not available responsive to a determination that the number of correlations in the chain is equal to the maximum number.

2. The computer-readable medium of claim 1, wherein the size recommendation is based at least in part on feedback from the user regarding another size recommendation.

3. The computer-readable medium of claim 1, further comprising code that encodes an item detail page including the size recommendation.

4. A system, comprising:
at least one computing device; and
a fit recommending application executable in the at least one computing device, the fit recommending application comprising:
logic that inputs a target item and a user item fit from a user;
logic that draws a chain of at least one correlation between the user item fit and a target item fit corresponding to the target item, wherein a correlation comprises an association of a first item fit corresponding to a first one of a plurality of items with a second item fit corresponding to a second one of the plurality of items; and
logic that generates a fit recommendation for the user regarding the target item comprising the target item fit.

5. The system of claim 4, wherein the user item fit is input from a purchase history corresponding to the user.

6. The system of claim 4, wherein the user item fit is input from a survey.

7. The method of claim 4, wherein the first item fit and the second item fit correspond to a first user.

8. The method of claim 4, wherein the first item fit corresponds to a first user and the second item fit corresponds to a second user.

9. The method of claim 4, the fit recommending application further including logic that associates a strength factor with each correlation.

10. A method, comprising the steps of:
inputting a user item fit corresponding to a user item and a target item from a user;
drawing, using a computing resource, a chain of at least one correlation between the user item fit and a target item fit corresponding to the target item; and
generating, using the computing resource, a fit recommendation for the user regarding the target item comprising the target item fit.

11. The method of claim 10, wherein inputting the user item fit from a user includes inputting the user item fit from a purchase history associated with the user.

12. The method of claim 10, wherein a correlation comprises an association of a first item fit corresponding to a first one of a plurality of items with a second item fit corresponding to a second one of the plurality of items.

13. The method of claim 10, wherein the user item fit includes at least two fit elements.

14. The method of claim 13, wherein the at least two fit elements comprise a brand and a size.

15. The method of claim 13, wherein drawing the chain further comprises the steps of:
determining whether the elements of one item fit in a pool of item fits correspond to a target item; and
defining the target item fit as comprising the one item fit responsive to a determination that the one item fit corresponds to the target item.

16. The method of claim 15, wherein drawing the chain further comprises the step of:
determining whether the one item fit is the last item fit in the pool responsive to a determination that the one item fit does not correspond to the target item.

17. The method of claim 16, wherein drawing the chain further comprises the steps of:
determining whether a number of correlations in the chain is equal to a maximum number; and
returning an indication that a target item fit is not available responsive to a determination that the number of correlations in the chain is equal to the maximum number.

18. The method of claim 17, wherein drawing the chain further comprises the steps of:
obtaining a next level pool of item fits correlated to the pool of item fits responsive to a determination that the number of correlations in the chain is not equal to the maximum number;
designating one item fit in the next level pool;
determining whether the elements of one item fit in the next level pool correspond to a target item; and
defining the target item fit as comprising the elements of the one item fit in the next pool responsive to a determination that the elements of the one item fit correspond to the target item.

19. The method of claim 10, further comprising the steps of:
inputting a search query from the user;
generating search results based at least in part on the search query including the target item; and
inputting the target item as a selection from the user.

20. The method of claim 10, further comprising the steps of:
encoding a network page including the fit recommendation using a computing resource; and
sending the network page from the computing resource to the client.
